(19) United States
(12) Patent Application Publication
(10) Pub. No.: US 2026/0222447 A1
(43) Pub. Date: Jul. 30, 2026

(54) SYSTEMS AND METHODS FOR TRANSFORMING DATA FROM DISPARATE DATA SOURCES INTO CURATED DATA CENTERS COMPRISING MULTI-TIERED SECURE TOKENS

(71) Applicant: BANK OF AMERICA CORPORATION, Charlotte, NC (US)

(72) Inventors: Manu Jacob Kurian, Dallas, TX (US); George Anthony Albero, Charlotte, NC (US); Naga Vamsi Krishna Akkapeddi, Charlotte, NC (US); Sandeep D. Tawakley, Simi Valley, CA (US)

(73) Assignee: BANK OF AMERICA CORPORATION, Charlotte, NC (US)

(21) Appl. No.: 19/038,383

(22) Filed: Jan. 27, 2025

(51) Int. Cl. H04L 9/40; H04L 41/16

(52) U.S. Cl. CPC H04L 63/166; H04L 41/16; H04L 63/105

(57) ABSTRACT

Systems, computer program products, and methods are described herein for transforming data from disparate data sources into curated data centers comprising multi-tiered secure tokens. The present disclosure is configured to identify a plurality of data sources, wherein the plurality of data sources comprises a plurality of datasets; generate at least one data center comprising a portion of the plurality of datasets, wherein the at least one data center comprises one or more datasets from a portion of data sources of the plurality of data sources, and wherein the at least one data center comprises a plurality of curation levels associated with the one or more datasets; and generate a curation token for each curation level of the plurality of curation levels, wherein the curation token is associated with a specific dataset comprising the associated curation level of a specific data center.

### TECHNOLOGICAL FIELD

Example embodiments of the present disclosure relate to the transmission of data from disparate data sources into curated data centers comprising multi-tiered secure tokens.

### BACKGROUND

In today's electronic environments where data is often transmitted over insecure networks and these data transmissions comprise data that may be unnecessary to resolve certain requests, it is increasingly important that only necessary data is transmitted in a secure, efficient, and automatic manner. Such secure data transmissions are necessary to prevent misappropriation of data, man-in-the-middle attacks, and to improve network data transmissions without the loss of data during these transmissions. Thus, a system that can automatically, efficiently, and dynamically transmit data from disparate data sources into curated data centers comprising multi-tier secure tokens is needed to mitigate or resolve these technical problems.

Applicant has identified a number of deficiencies and problems associated with generating data centers comprising data from disparate sources for automatic and secure data transmissions. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for transmitting data from disparate data sources into curated data centers comprising multi-tiered secure tokens.

In one aspect, a system for transforming data from disparate data sources into curated data centers comprising multi-tiered secure tokens is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify a plurality of data sources, wherein the plurality of data sources comprises a plurality of datasets; generate at least one data center comprising a portion of the plurality of datasets, wherein the at least one data center comprises one or more datasets from a portion of data sources of the plurality of data sources, and wherein the at least one data center comprises a plurality of curation levels associated with the one or more datasets; and generate a curation token for each curation level of the plurality of curation levels, wherein the curation token is associated with a specific dataset comprising the associated curation level of a specific data center.

In some embodiments, each curation level comprises at least one version identifier associated with an updated version for each dataset of the one or more datasets. In some such embodiments, executing the computer-readable code is further configured to cause the at least one processing device to: generate, based on each curation level and the at least one version identifier, at least one tier indicator for each curation level, wherein each tier indicator comprises data source information for each dataset in each data center. In some additional embodiments, executing the computer-readable code is further configured to cause the at least one processing device to: generate, based on each tier indicator, a graphical neural network (GNN), wherein the GNN comprises each tier indicator and each curation token associated with each tier indicator; identify at least one data transmission request; and determine, by the GNN, at least one curation token based on the associated curation level and the at least one data source of the curation token, wherein the at least one curation token determined by the GNN is based on resolving the at least one data transmission request.

In some embodiments, executing the computer-readable code is further configured to cause the at least one processing device to: identify at least one data transmission request token, wherein the at least one data transmission request token is generated from at least one historical data transmission request; access a graphical neural network (GNN) using the at least one data transmission request token, wherein the GNN is pretrained with a plurality of tiers associated with a plurality of curation tokens; determine, using the GNN, at least one dataset to resolve the at least one data transmission request token; identify, by the GNN and based on the at least one dataset to resolve the at least one data transmission request, a curation level for the at least one dataset; identify, by the GNN, a specific curation token associated with the at least one dataset and based on the at least one curation level identified for the at least one dataset; apply the curation token to the data center associated with the curation token; and access, based on the application of the curation token, the at least one dataset at the at least one curation level within the data center.

In some embodiments, the at least one data center comprises at least a portion of data from a plurality of data sources, and the portion of data is separated based on at least one of a curation level and a version identifier within the at least one data center.

In some embodiments, the plurality of data sources comprises a plurality of applications, databases, or repositories.

In some embodiments, the at least one dataset is one or an unstructured dataset or a structured dataset.

In some embodiments, the curation level is associated with at least one of a raw data of the portion of the plurality of datasets, a validated portion of the plurality of datasets, or an enriched portion of the plurality of datasets.

In some embodiments, the curation level is organized within the datacenter based on a tier identifier, and wherein the tier level indicates a hierarchy of data enrichment for the portion of the plurality of datasets.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for transmitting data from disparate data sources into curated data centers comprising multi-tiered secure tokens, in accordance with an embodiment of the disclosure;

FIG. 2 illustrates an exemplary Graphical Neural Network (GNN) subsystem architecture, in accordance with an embodiment of the disclosure;

FIG. 3 illustrates a process flow for transmitting data from disparate data sources into curated data centers comprising multi-tiered secure tokens, in accordance with an embodiment of the disclosure;

FIG. 4 illustrates a process flow for determining a curation token associated with a curation level of data within data center, in accordance with an embodiment of the disclosure;

FIG. 5 illustrates a process flow for accessing—using a curation token—the dataset(s) within the data center upon the GNN identifying the appropriate curation token for a data transmission request, in accordance with an embodiment of the disclosure;

FIG. 6 illustrates a flow diagram for generating a plurality of data centers from a plurality of data sets and data sources, in accordance with an embodiment of the disclosure; and

FIG. 7 illustrates a flow diagram for determining curation tokens and their associated data sets and curation levels within a data center, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

In today's electronic environments where data is often transmitted over insecure networks and these data transmissions comprise data that may be unnecessary to resolve certain requests, it is increasingly important that only necessary data is transmitted in a secure, efficient, and automatic manner. Such secure data transmissions are necessary to prevent misappropriation of data, man-in-the-middle attacks, and to improve network data transmissions without the loss of data during these transmissions. Thus, a system that can automatically, efficiently, and dynamically transmit data from disparate data sources into curated data centers comprising multi-tier secure tokens is needed to mitigate or resolve these technical problems.

Accordingly, the present disclosure comprises an identification of a plurality of data sources, wherein the plurality of data sources comprises a plurality of datasets; the generation of at least one data center comprising a portion of the plurality of datasets, wherein the at least one data center comprises one or more datasets from a portion of data sources of the plurality of data sources, and wherein the at least one data center comprises a plurality of curation levels associated with the one or more datasets; and the generation of curation token for each curation level of the plurality of curation levels, wherein the curation token is associated with a specific dataset comprising the associated curation level of a specific data center. Additionally, and in some embodiments, the present disclosure may further provide for the generation of, based on each curation level and the at least one version identifier, at least one tier indicator for each curation level, wherein each tier indicator comprises data source information for each dataset in each data center. Further, and based on this tier indicator, the present disclosure provides for the generation of a graph neural network (GNN), and based on applying a data transmission resource token to the GNN, the system may identify a curation token (based on the data source, data set(s), and the tier indicator associated with curation token) that can resolve the data transmission request.

Additionally, and in some embodiments, the disclosure may provide the identification of least one data transmission request token, wherein the at least one data transmission request token is generated from at least one historical data transmission request; the access of a graphical neural network (GNN) using the at least one data transmission request token, wherein the GNN is pretrained with a plurality of tiers associated with a plurality of curation tokens; and the determination, using the GNN, of at least one dataset to resolve the at least one data transmission request token. Further, and in some embodiments, the disclosure may provide the identification, by the GNN and based on the at least one dataset to resolve the at least one data transmission request, of a curation level for the at least one dataset; the identification, by the GNN, of a specific curation token associated with the at least one dataset and based on the at least one curation level identified for the at least one dataset; the application of the curation token to the data center associated with the curation token; and the access, based on the application of the curation token, of the at least one dataset at the at least one curation level within the data center.

In other words, the disclosure provides a system for automatically and dynamically combining and sorting data from a plurality of disparate data sources (e.g., disparate applications, data storages, and/or the like) into one or more data centers or hubs. For each of these data centers, a plurality of curation levels may be used to store the curated data at different blocks within a distributed ledger, whereby the curation levels may indicate a level of finetuning the data for application consumption (e.g., the more refined, more annotated, more validated, more enriched, and/or the like, the higher the curation level). Additionally, and in some embodiments, the data centers and their curation levels may be represented as curation tokens within a graph neural network (GNN). Such a GNN may be trained and configured to determine the appropriate datacenter and curation level for a request by a user. Thus, and depending on the need for the data, the system—using the GNN—may identify an appropriate data center that comprises the needed data and identify an associated curation level within that data center. Based on the identification of the curation token for a specific data center, the system may allow access to the underlying data within the data center at the specified curation level, while maintaining a secure and efficient recall system for data from multiple disparate data sources.

What is more, the present disclosure provides a technical solution to a technical problem. As described herein, the technical problem includes the collection, organization, and storage of data from disparate data sources for secure data transmissions. The technical solution presented herein allows for transmission of data from disparate data sources into curated data centers comprising multi-tiered secure tokens. In particular, the system described herein is an improvement over existing solutions to the technical problems described herein, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

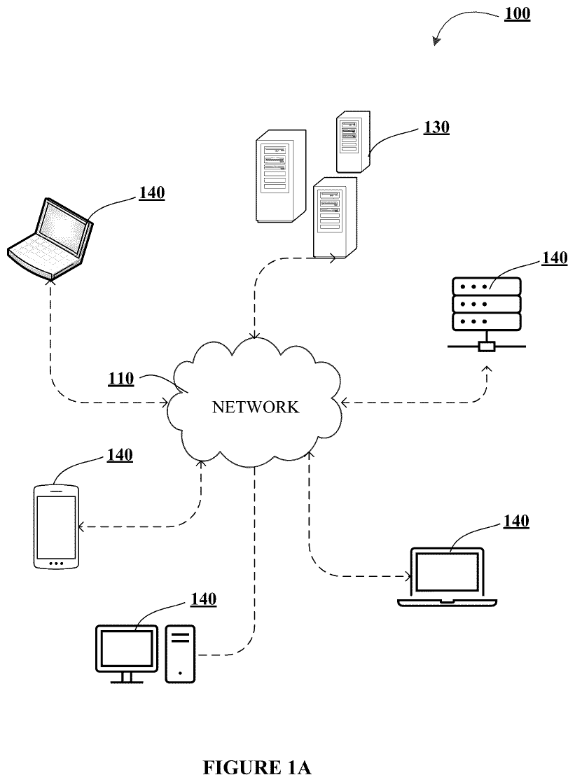

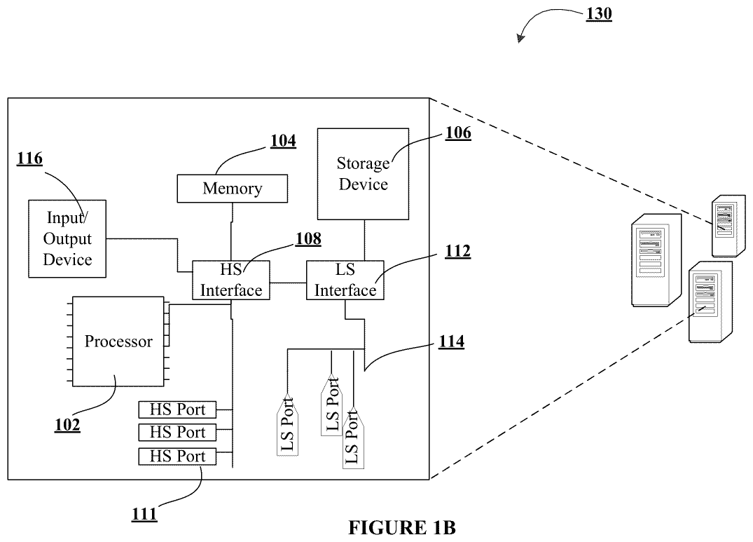

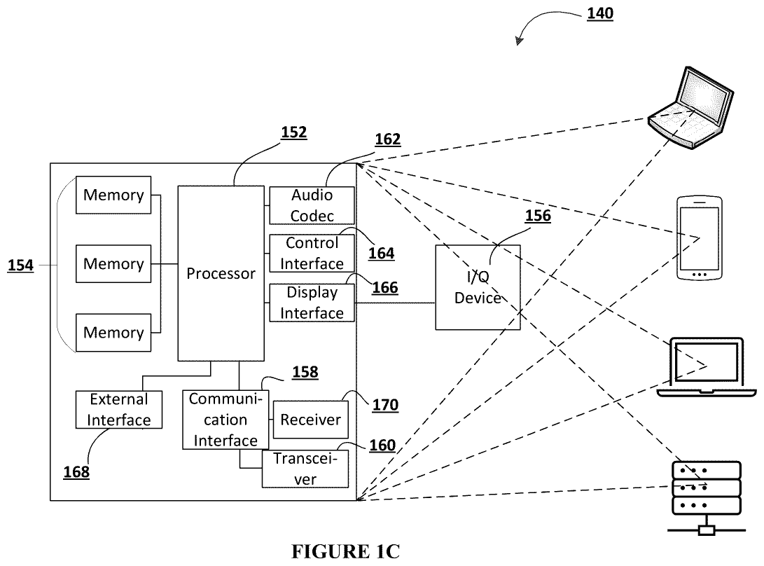

FIGS. 1A-1C illustrate technical components of an exemplary distributed computing environment for transmitting data from disparate data sources into curated data centers comprising multi-tiered secure tokens 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

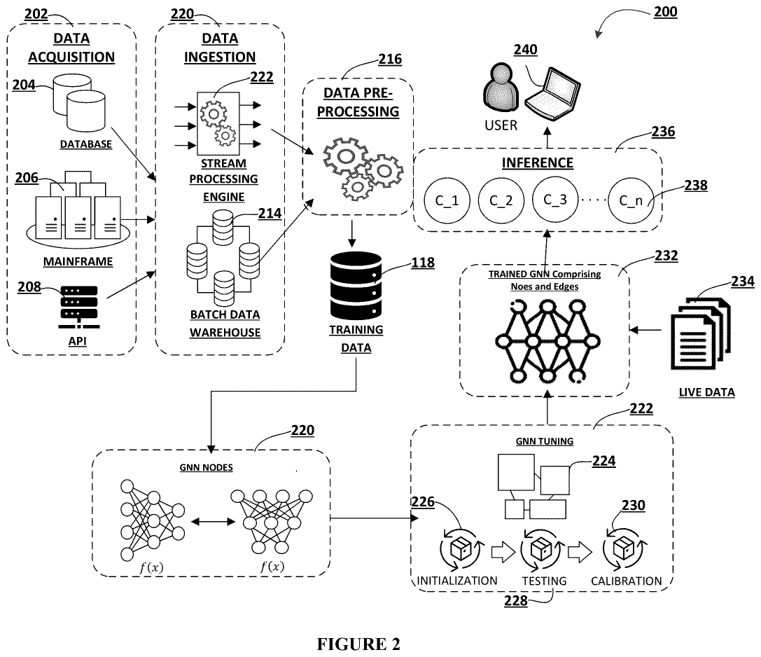

FIG. 2 illustrates an exemplary Graphical Neural Network (GNN) subsystem architecture 200, in accordance with an embodiment of the disclosure. The GNN subsystem 200 may include a data acquisition engine 202, data ingestion engine 210, data pre-processing engine 216, GNN nodes 220, GNN tuning engine 222, the trained GNN 232, and inference engine 236.

The data acquisition engine 202 may identify various internal and/or external data sources to generate, test, and/or integrate new features for training the GNN engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the GNN 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of graphical neural network algorithm being used, this training data 218 may require further enrichment. For example, in supervised learning, the training data is enriched using one or more meaningful and informative labels to provide context so a GNN can learn from it. For example, labels might the data enriched and used at each curation level within the GNN, and the relationships between the data at each curation level and the source (or application) the data was collected from. In contrast, unsupervised learning uses unlabeled data to find patterns in the data, such as inferences or clustering of data points.

The GNN tuning engine 222 may be used to train an GNN 224 using the training data 218 to make predictions or decisions without explicitly being programmed to do so. The GNN 224 represents what was learned by the selected GNN 220 and represents the rules, relationships, and any other algorithm-specific data structures required for classification. Selecting the right GNN algorithm may depend on a number of different factors, such as the problem statement and the kind of output needed, type and size of the data, the available computational time, number of features and observations in the data, and/or the like. GNN algorithms may refer to programs (math and logic) that are configured to self-adjust and perform better as they are exposed to more data. To this extent, GNN algorithms are capable of adjusting their own parameters, given feedback on previous performance in making prediction about a dataset.

The GNN algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable GNN engine type. Each of these types of GNN algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the GNN, the GNN tuning engine 222 may repeatedly execute cycles of experimentation 226, testing 228, and tuning 230 to optimize the performance of the GNN algorithm 220 and refine the results in preparation for deployment of those results for consumption or decision making. To this end, the GNN tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained GNN 232 is one whose hyperparameters are tuned and engine accuracy maximized.

The trained GNN 232, similar to any other software application output, can be persisted to storage, file, memory, or application, or looped back into the processing component to be reprocessed. More often, the trained GNN 232 is deployed into an existing production environment to make practical business decisions based on live data 234. In some such embodiments, the GNN subsystem 200 may use the inference engine 236 to make such decisions. The type of decision-making may depend upon the type of GNN algorithm used. For example, GNNs trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, GNNs that perform regression techniques may use live data 234 to predict or forecast continuous outcomes.

It will be understood that the embodiment of the GNN subsystem 200 illustrated in FIG. 2 is exemplary and that other embodiments may vary. As another example, in some embodiments, the GNN subsystem 200 may include more, fewer, or different components.

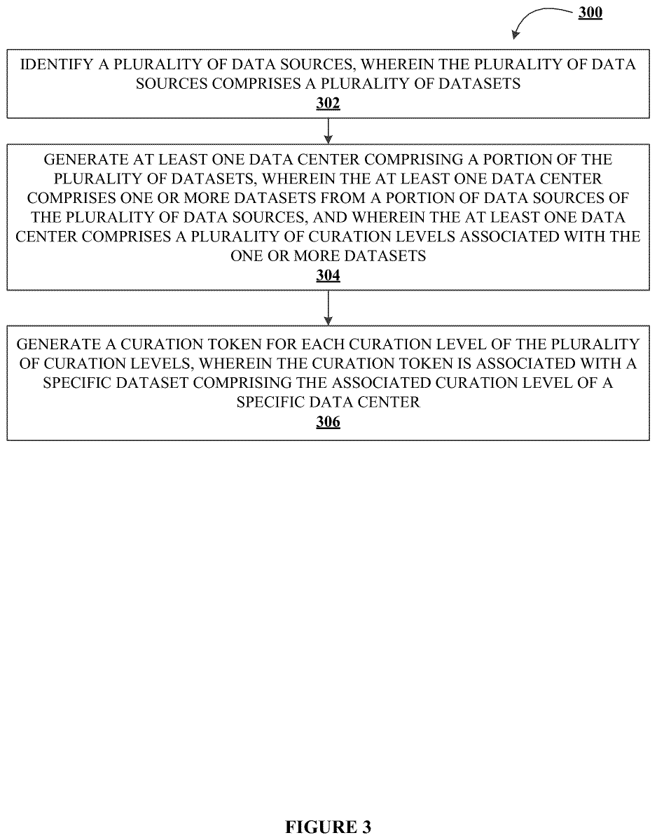

FIG. 3 illustrates a process flow 300 for transmitting data from disparate data sources into curated data centers comprising multi-tiered secure tokens, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300. In some embodiments, an GNN (e.g., such as the GNN shown in FIG. 2) may perform some or all of the steps described in process flow 300.

As shown in block 302, the process flow 300 may include the step of identifying a plurality of data sources, wherein the plurality of data sources comprises a plurality of datasets. For example, and as used herein, a data sources may comprise an application, a database, a repository, and/or the like. Thus, and as used herein, the data source may refer to a computing component which is configured to and/or capable of receiving data, collecting the data and/or storing the data. In some embodiments, and where the data sources doesn't have its own data storage capability, but the data source does have the capability to transmit its data to a separately run storage component (e.g., remotely run at a separate data center from the data source). In some embodiments, the system may identify a plurality of data source which may comprise an plurality of applications, where each application may comprise its own dataset or plurality of datasets associated with one or more user accounts, user data, application-generated data, and/or the like.

In some embodiments, the data source(s) may be identified by the system based on receiving a user account identifier associated with a user account of the system and/or a user account of a data source associated with the system. Thus, and in some embodiments, the system may use the received user account identifier to identify a plurality of data sources that each have at least one dataset associated with the same user account identifier and/or a same user account that matches or is associated with the user account identifier. Therefore, and in some such embodiments, the system may identify all the data sources the user account has datasets stored in and/or collected at, and based on this identification, the system may access each of these data sources and collect the datasets associated with the user account to generate one or more datacenters.

Additionally, and/or alternatively, the system may identify a plurality of data sources associated with a plurality of user accounts and/or a plurality of datasets, whereby the system may identify these data sources based on the datasets the data sources store, receive, and/or collect. In some such embodiments, the system may identify particular datasets that need to be used to generate and/or update one or more data centers. Thus, and in some embodiments where one or more data centers have already been generated by the system, the system may be configured to regularly update the data centers based on an update to the underlying data within each data center from one or more data sources and their updated datasets.

As shown in block 304, the process flow 300 may include the step of generating at least one data center comprising a portion of the plurality of datasets, wherein the at least one data center comprises one or more datasets from a portion of data sources of the plurality of data sources, and wherein the at least one data center comprises a plurality of curation levels associated with the one or more datasets. For instance, the system may generate at least one data center using data from one or more datasets associated with one or more data sources. In this manner, each data center generated by the system may comprise a combination of data from one or more datasets from one or more data sources.

Additionally, each data center may further comprise a plurality of curation levels for each dataset (or portion of datasets) and/or each combination of datasets (or portion of combination of datasets). As used herein, a curation level refers to an indicator of the accessibility and usability of the dataset(s) within the data center(s). Thus, and by way of non-limiting example, a lowest curation level may comprise only raw data for the associated dataset(s) at the lowest curation level in the data center, and then a second or higher level curation level may comprise a more enriched version of the raw data associated with the first curation level and any other such data used to enrich the raw data. Additionally, and by way of non-limiting example, another higher curation level may comprise both enriched and validated data, or only validated data, and/or the like. Thus, and based on the description provided herein regarding curation levels, a person of skill in the art would understand that the curation levels used herein refers to a level of preparing data within the datasets associated with a data center for processing (such as for resolving or completing a data transmission request), whereby each dataset may be separated or organized within the data center based on their associated curation level.

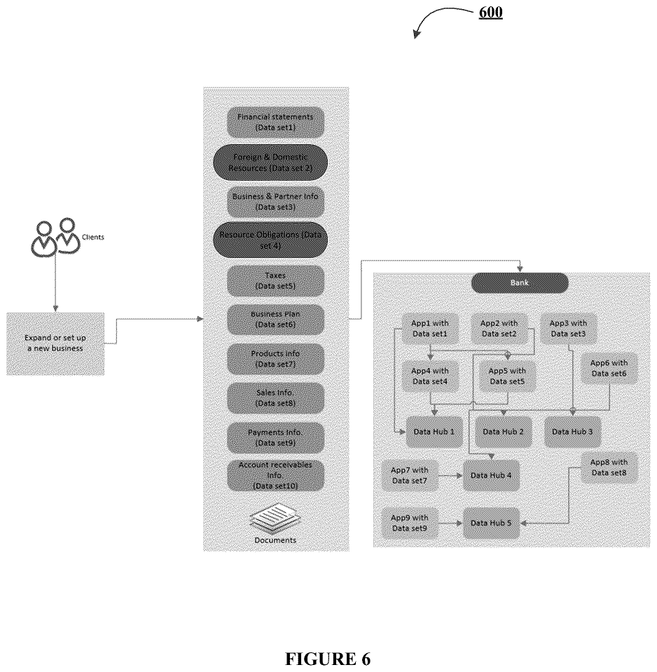

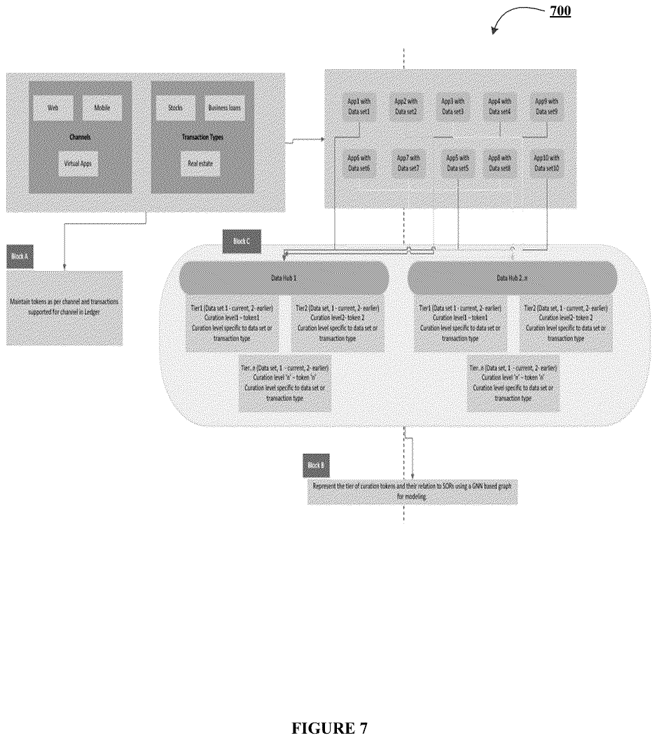

Thus, and as used herein, each data center (or “data hub”) refers to a collection of data from one or more data sources at different curation levels that are ready for consumption or use for different purposes. In other words, the data centers may be generated by clustering, combining, and/or the like, a plurality of datasets and/or a plurality of portions of one or more datasets from a plurality of data sources. Thus, and by way of non-limiting example, if a user associated with a user account identifier had different data across many different applications and the user intended to apply for a data transmission request (e.g., a data transmission request comprising a loan application), but in order to complete the data transmission request, the datasets from the plurality of applications needed to be collected and assessed. Therefore, the system described herein may first generate a plurality of data centers using the data from the applications in order to complete one or more data transmission requests. For instance, one or more datasets associated with one or more data sources may comprise financial statements (data set 1 from application 1), foreign and domestic resources (data set 2 associated with application 2), business and partner information (dataset 3 associated with application 3), resource obligations information (data set 4 associated with application 4), taxes information (dataset 5 associated with application 5), business plans information (dataset 6 associated with application 6), and/or the like. Further, and in generating a first data center, only dataset 1, dataset 2, dataset 4, and dataset 5 may be used to generate data center comprising the information needed to complete a loan application. Therefore, and by way of non-limiting example, the system may automatically generate one or more data centers comprising one or more datasets (and/or portions of one or more datasets), and such data centers may be used to complete one or more data transmission requests. Additionally examples of how a plurality of data centers are generated from a plurality of data sources are shown and described below with respect to FIGS. 6 and 7.

Additionally, and as described herein, the one or more data centers may additionally comprise one or more curation levels, whereby each curation level may indicate the level of usability of the data within the data center to complete the one or more data transmission requests. For instance, and where the data transmission request would require a set of validated data, then the curation levels associated with only raw data and/or enriched data (e.g., without any such validity), may not be used by the system for completing the data transmission request.

Additionally, and in some embodiments, each curation level may be used by the system to store the associated dataset(s) at each curation level in its own block within a distributed ledger. In this manner, and in some such embodiments, upon identifying an appropriate curation token to resolve a data transmission request, the system may use the curation token to access the distributed ledger comprising the associated curation level and dataset(s) of the data center and the block within the distributed ledger may be accessed for processing and completing of the data transmission request.

In some embodiments, each curation level may comprise at least one version identifier associated with an updated version for each dataset of the one or more datasets. In other words, and in some such embodiments, as the underlying data within the data centers are updated (e.g., updated within the data centers themselves and/or updated in the one or more data sources the data sets were collected from), the system may automatically and in real time or near real time update the data within the data center and update a version identifier associated with the data center to indicate the new version of data within the data center. In some such embodiments, and where a data center comprises a plurality of datasets from a plurality of data sources, and where only one dataset has been updated, then the version identifier for the entire data center may be updated to indicate that at least a portion or all of the of the data was updated in the data center. In some embodiments, each version identifier and associated version of data within the data center may be collected and stored in a distributed ledger, and each version of data and version identifiers may be immutably stored for future reference. In some such embodiments, each version and associated data may be stored on a distributed ledger.

As show in block 306, the process flow 300 may include the step of generating a token for each curation level of the plurality of curation levels, wherein the curation token is associated with a specific dataset comprising the associated curation level of a specific data center. For example, and in some embodiments, the system may generate a token for each curation level for each data center, whereby each curation token may be associated with a particular curation level within a particular data center. Thus, and in some such embodiments, each data center may comprise a plurality of curation tokens, and each curation token may be associated with a specific combination of data set(s) at a specific curation level that are used to generate the data center. In some embodiments, the curation token may be a secure token, such as a cryptographic token, a cryptographic key, and/or the like. In some embodiments, and where the token comprises a cryptographic token, the token may be shared to one or more applications and/or the like, and used by the one or more applications to access the underlying data associated with the specific data center at the specific curation level associated with the curation token.

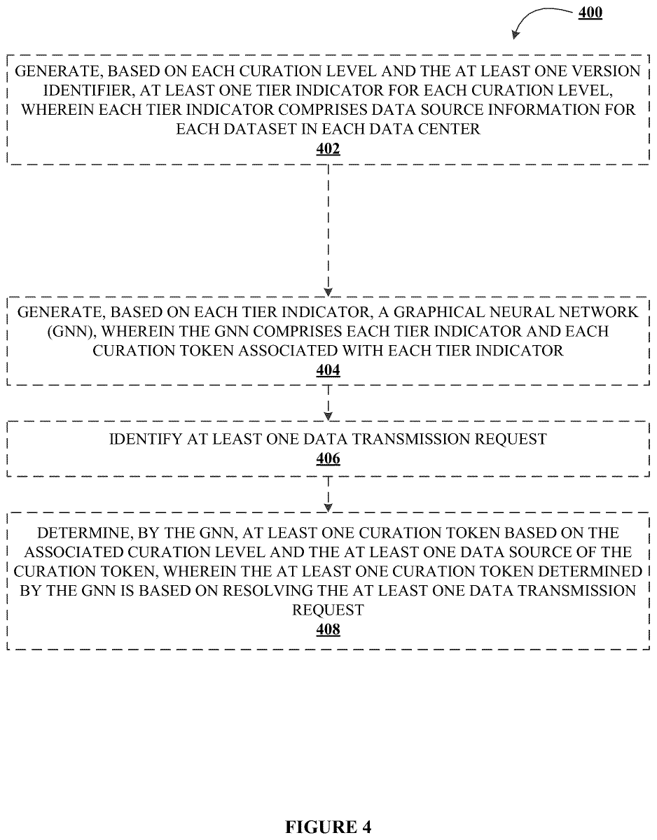

FIG. 4 illustrates a process flow 400 for determining a curation token associated with a curation level of data within data center, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. In some embodiments, an GNN (e.g., such as the GNN shown in FIG. 2) may perform some or all of the steps described in process flow 400.

In some embodiments, a determination that each curation level comprises at least one version identifier associated with an updated version for each dataset of the one or more datasets may occur before the processes described herein with respect to FIG. 4. For example, and in some embodiments, the system may determine a new version of the data within a data center is present, and thus, the system may update the version identifier for each curation level comprising the updated data with a new version identifier. In some such embodiments, each version of the dataset(s) within the data center may be tracked and stored with an associated version identifier, which may be used by the system described herein to accurately keep track of the datasets, and each dataset's associated current and/or historical versions.

In some embodiments, and as shown in block 402, the process flow 400 may include the step of generating, based on each curation level and the at least one version identifier, at least one tier indicator for each curation level, wherein each tier indicator comprises data source information for each dataset in each data center. For example, and in some such embodiments, the system may generate—based on the curation level at issue and the associated current version identifier—at least one tier indicator that is specific to the data center, a specific curation level within the data center, and a specific version identifier within the data center at the curation level. Thus, and in some such embodiments, the tier indicator may be based on the curation level for each dataset within the data center and each version identifier for the associated dataset. Thus, and in some embodiments where a data center comprises a plurality of portions of datasets from a plurality of data sources, the system may generate a version identifier whenever any data within the portions of the datasets of the data center are updated, even in an instance where not all data within the portions of the datasets organized in the data center are updated at a same time. Thus, and upon generating the new version identifier, the system may likewise generate a new tier indicator for the updated version identifier.

Additionally, and in some embodiments, the tier indicator for each curation level and each associated dataset may further comprise data source information (such as system of record, or “SOR,” information) for each data set in each data center. In some such embodiments, the tire indicator may further comprise information regarding where the dataset(s) within the data center have come from, such as but not limited to where the data was/is created, stored, managed, and/or the like. In some embodiments, and based on this data source information, the tier indicator may be used by the system to determine relationships between each data source and their associated data centers, which may then be used by the system to accurately and efficiently determine which data center should be accessed to gather the information within the dataset(s) to complete a data transmission request. Such an embodiment is described in further detail below.

In some embodiments, and as shown in block 404, the process flow 400 may include the step of generating, based on each tier indicator, a graphical neural network (GNN), wherein the GNN comprises each tier indicator and each curation token associated with each tier indicator. For example, and in some such embodiments, the system may generate a GNN (like the GNN shown and described with respect to FIG. 2) which may comprise information regarding the relationships between data centers (based on relationships between the curation tokens and associated tier indicators which comprises data source information), such that the GNN may be used by the system to determine which data centers at which curation level data should be collected from in order to complete a data transmission request. In some embodiments, the GNN may comprise nodes indicating the curation tokens and their tier indicators with data source information. Thus, and in other words, the GNN may represent the tier(s) of curation tokens and their relationships to data sources using the GNN based graph for modeling. In some embodiments, the system may identify a data transmission request token associated with the data transmission request, and the system may use this data transmission request token as an input to the GNN. The GNN may then identify the appropriate or correct tier of curation tokens needed to complete the data transmission request based on a pretraining of the GNN and the relationships indicated by the GNN between the curation tokens (and their tier levels) and the data sources for each curation token and data center. Thus, and in some such embodiments, the GNN may represent data sets curations as multi-tiered curation tokens that define the different curation levels within each data center. Therefore, and in some such embodiments, the network of tokenization may be represented as a grandparent-parent-child relationship (multi-generational tier network) for each curation token and each data center comprising the different curation tokens.

In some embodiments, and as shown in block 406, the process flow 400 may include the step of generating, based on each tier indicator, a graphical neural network (GNN), wherein the GNN comprises each tier indicator and each curation token associated with each tier indicator. Thus, and in some such embodiments, the system may generate the GNN to comprise each tier indicator and each curation token as a multi-tier relationship for each data center. Therefore, the GNN may comprise information indicating the relationships between each level of curation tokens and their data sources within the tier indicator. In some embodiments, the tier indicator may further comprise the version indicator for the underlying data within the data center and for each curation token. Thus, and based on the information within the GNN, the system may use the information provided in the data transmission request to determine the most correct and/or optimal data center and optimal curation level data should be collected from in order to complete the data transmission request. By way of non-limiting example, and where the data transmission request really only requires raw data that could be generated by a user associated with the user account identifier, then the GNN may identify a data center comprising the data needed to complete the data transmission request and the correct curation level as the curation level 1 (e.g., a raw data curation level) rather than another higher curation level.

In some embodiments, and as shown in block 408, the process flow 400 may include the step of identifying at least one data transmission request. In some such embodiments, and as described above, the system may identify at least one data transmission request by receiving a data transmission request from a user device associated with the user account identifier of the one or more datasets. In some embodiments, the data transmission request may be received from a remote application, system, and/or the like, such as a remote application requesting information of a user that submitted a request to complete a data transmission request. Thus, and in some such embodiments, the remote application may submit the data transmission request to the system, and once the system has determined the correct curation token to complete the data transmission request the curation token may transmitted to the remote application for access to the underlying data within the associate data center using the curation token.

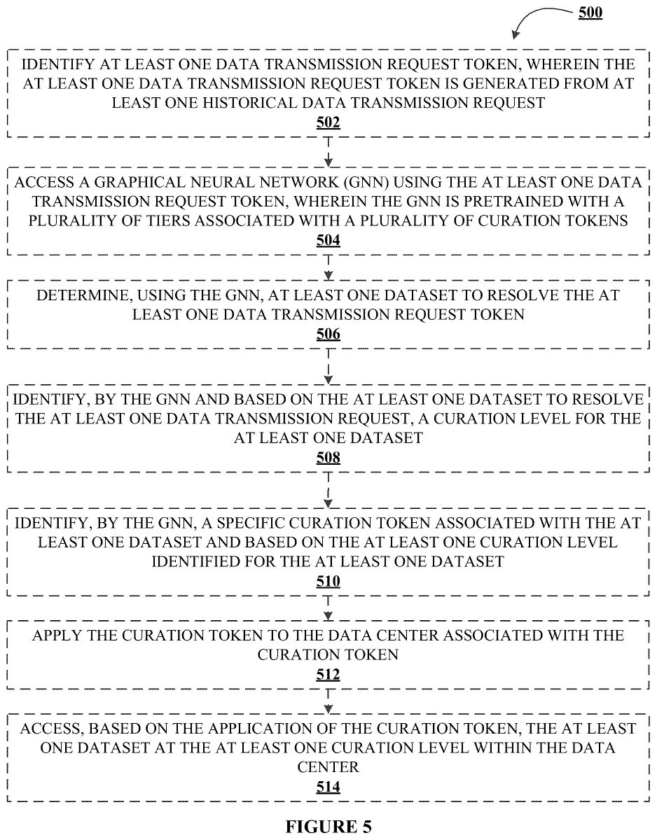

In some embodiments, and as shown in block 408, the process flow 400 may include the step of determining, by the GNN, at least one curation token based on the associated curation level and the at least one data source of the curation token, wherein the at least one curation token determined by the GNN is based on resolving the at least one data transmission request. For instance, and in some such embodiments, the use the GNN to determine a correct curation token for a data center comprising the data needed to complete the data transmission request. Thus, and using the data transmission request as an input, the GNN may analyze each of the tier indicators (which may include analyzing the data sources for each tier indicator) and their associated curation tokens to determine which curation token may be the most appropriate to complete the data transmission request. In some embodiments, the determination of which curation token is most appropriate to complete the data transmission request may comprise the system generating a standard data transmission request token using historical data transmission requests and the associated data that was used to complete the data transmission requests to determine which data center to access and at what curation level (which may be based on historical data sources and datasets used to complete the data transmission requests). Such an embodiment is described in further detail below with respect to FIG. 5.

FIG. 5 illustrates a process flow 500 for accessing—using a curation token—the dataset(s) within the data center upon the GNN identifying the appropriate curation token for a data transmission request, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. In some embodiments, an GNN (e.g., such as the GNN shown in FIG. 2) may perform some or all of the steps described in process flow 500.

In some embodiments, and as shown in block 502, the process flow 500 may include the step of identifying at least one data transmission request token, wherein the at least one data transmission request token is generated from at least one historical data transmission request. For instance, and in some such embodiments, the system may identify at least one data transmission request, such as a data transmission request received from a user device associated with a user or client of the system. By way of non-limiting example, such a data transmission request may comprise a request for data to be transmitted from one or more applications or one or more data sources to another application, computer network, computing system, data center, and/or the like for processing. By way of non-limiting example, the data transmission request may comprise a request to initiate an application for a resource transaction, such as but not limited to a request to initiate a loan application.

Further, and based on such a data transmission request, the system may identify at least one data transmission request token that has been pre-generated and matches the data transmission request. Thus, and in some such embodiments, the system may comprise a database, a repository, a data storage component, and/or the like, that comprises a plurality of data transmission request tokens that may be compared to the current data transmission request and used upon identifying the appropriate data transmission request token, the process described herein with respect to FIG. 5 may be triggered. Thus, and in some embodiments, the data transmission request tokens may be pre-generated from at least one historical data transmission request. Therefore, and in some such embodiments, the system may track and/or store each of the historical data transmission requests received and the associated data transmission request tokens generated and used to indicate the data transmission requests within the GNN for determining the appropriate data center and curation level.

In some embodiments, and as shown in block 504, the process flow 500 may include the step of accessing a graphical neural network (GNN) using the at least one data transmission request token, wherein the GNN is pretrained with a plurality of tiers associated with a plurality of curation tokens. For example, and in some such embodiments, the system may access the GNN with the data transmission request token(s) identified in block 502. Further, and as described briefly above, the GNN may be pre-trained with a plurality of tiers indicating the plurality of tokens associated with each data center, and based on the organization of the GNN with each tier of curation tokens and their associated datasets, the system—using the GNN—may determine at least one dataset that will meet the data transmission request token. In some such embodiments, the GNN may comprise tier indicators for each curation token, whereby such tier indicators may comprise information/data regarding the data source(s) each dataset for each data center has been received from. Thus, and in some such embodiments, the GNN may comprise data regarding the data sources used for each data center and curation token, and such data sources and their datasets may be used by the GNN to accurately identify which data centers and their associated curation tokens (e.g., curation level) would be the most appropriate and optimal to use for resolving and/or completing the data transmission request of the data transmission request token. Thus, and in some such embodiments, the system may use the data transmission request token as an input to the GNN to resolve or complete the data transmission request token.

In some embodiments, and as shown in block 506, the process flow 500 may include the step of determining, using the GNN, at least one dataset to resolve the at least one data transmission request token. For instance, and as described above, the system may determine at least one dataset and an associated data source that can resolve or complete the data transmission request. Thus, and in some such embodiments, the GNN may be trained and configured to determine which dataset(s), from which data source(s), and at which curation level, may be used to resolve each data transmission request token, and thus, the GNN may determine which associated curation token matches each of these specified dataset(s), specified data source(s), and specified curation level.

In some embodiments, and as shown in block 508, the process flow 500 may include the step of identifying, by the GNN and based on the at least one dataset to resolve the at least one data transmission request, a curation level for the at least one dataset. For instance, and in some such embodiments, the system may identify a curation level that can resolve the data transmission request. Such an identification of the curation level may comprise a determination of a curation level for a dataset within the data center that can resolve the data transmission request without unduly showing too much data that is unnecessary for completing the data transmission request (e.g., if only raw data is needed, a first curation level of the dataset may be used instead of using a higher curation level comprising enriched and/or validated data).

In some embodiments, and as shown in block 510, the process flow 500 may include the step of identifying, by the GNN, a specific curation token associated with the at least one dataset and based on the at least one curation level identified for the at least one dataset. For example, the system may identify—using the GNN—a specific curation token that matches at least the specified dataset(s) and curation level of blocks 506 and 508. Thus, and based on the identification of the dataset(s) and the appropriate curation level, the system may identify the associated curation token that matches/comprises these specified dataset(s) and curation level. Further, and based on identifying the curation token, the system may thus also identify the associated data center that comprises the curation token.

In some embodiments, and as shown in block 512, the process flow 500 may include the step of applying the curation token to the data center associated with the curation token. For instance, and in some such embodiments, the system may apply the curation token identified by the GNN to the data center that comprises the dataset specified in the curation token. Thus, and in some such embodiments, the curation token may comprise a cryptographic token which may be used to access the dataset(s) at the curation level within the data center in a secure and direct manner. In some such embodiments, the curation token may be used as a key to access the data within the data center at the curation level specified by the curation token.

In some embodiments, the curation token may be applied by an entity that generated and/or transmitted the data transmission request to the system described herein. In some such embodiments, the system may transmit the curation token to a user device associated with the entity that generated or transmitted the data transmission request, and the entity—using their user device—may transmit the curation token to the correct data center to access the associated data at the curation level.

In some embodiments, and as shown in block 514, the process flow 500 may include the step of accessing, based on the application of the curation token, the at least one data set at the at least one curation level within the data center. Thus, and in some such embodiments, the system may access—using the curation token—the dataset(s) comprised within the data center at the specified curation level. In some embodiments, the curation token being applied to the data center may automatically and efficiently access the correct curation level and dataset(s) associated with the curation token, and based on this accessing, the data within the dataset(s) may be used to automatically complete the data transmission request (e.g., complete a loan application with the appropriate data of the user in a secure and efficient manner).

FIG. 6 illustrates a flow diagram 600 for generating a plurality of data centers from a plurality of data sets and data sources in accordance with an embodiment of the disclosure. In some embodiments, a system (e.g., similar to one or more of the systems described herein with respect to FIGS. 1A-1C) may perform one or more of the steps of flow diagram 600. For example, a system (e.g., the system 130 described herein with respect to FIG. 1A-1C) may perform the steps of flow diagram 600. In some embodiments, an GNN (e.g., such as the GNN shown in FIG. 2) may perform some or all of the steps described in flow diagram 600.

For instance, and as shown in flow diagram 600, a plurality of datasets associated with a plurality of applications (data sources) may be used as input into a plurality of distinct data hubs (i.e., data hub 1, data hub 2, data hub 3, data hub 4, and data hub 5) which may each comprise copies of the same data from the same datasets and/or copies of data from different and distinct data sets.

FIG. 7 illustrates a flow diagram 700 for determining curation tokens and their associated data sets and curation levels within a data center, in accordance with an embodiment of the disclosure. In some embodiments, a system (e.g., similar to one or more of the systems described herein with respect to FIGS. 1A-1C) may perform one or more of the steps of flow diagram 700. For example, a system (e.g., the system 130 described herein with respect to FIG. 1A-1C) may perform the steps of flow diagram 700. In some embodiments, an GNN (e.g., such as the GNN shown in FIG. 2) may perform some or all of the steps described in flow diagram 700.

For example, and as shown in flow diagram 700, the system may identify a data transmission request and their associated channel (e.g., a data transmission request may comprise different types of business transactions such as but not limited to stocks, business loans, real estate, and/or the like, from a channel such as but not limited to a web channel, a mobile device channel, a virtual application channel, and/or the like). Further, and based on identifying the data transmission request, the system may maintain data transmission tokens based on the channel and the data transmission request type. In some such embodiments, the data transmission request tokens may be stored in a distributed ledger, a database, a repository, and/or the like.

Additionally, and as shown in flow diagram 700, the system may generate different data centers (e.g., data hub 1 and data hub 2) from a plurality of datasets (e.g., app 1 with data set 1, app 2 with data set 2, app 3 with data set 3, app 4 with data set 4, app 9 with data set 9, app 6 with data set 6, app 7 with data set 7, app 5 with data set 5, app 8 with data set 8, and app 10 with data set 10). Such data centers (data hub 1 and data hub 2) may comprise different curation levels and at different tiers (e.g., data hub 1 may comprise tier 1 (with data set 1, curation level 1, and curation token 1), data hub 1 may comprise tier 2 (with data set 1, curation level 2, and curation token 2), data hub may comprise tier n (with data set 1, curation level n, and curation token n); data hub 2 may comprise tier 1 (with data set 1, curation level 1, and curation token 1), data hub 2 may comprise tier 2 (with data set 1, curation level 2, and curation token 2), and data hub 2 may comprise tier n (with data set 1, curation level n, and curation token n)). Thus, and as shown in process flow 700, the datasets used for each data hub may comprise distinct data from distinct applications and data sources comprising different datasets. Additionally, and importantly, the system may represent the tier of the curation tokens from each data center and their relation to their data source(s) using the GNN based graph described above. Such a GNN may then be used to identify the appropriate dataset(s) that can be used to resolve the data transmission request token(s).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for transforming data from disparate data sources into curated data centers comprising multi-tiered secure tokens, the system comprising:
a memory device with computer-readable program code stored thereon;
at least one processing device operatively coupled to the memory device and at least one communication device, wherein executing the computer-readable code is configured to cause the at least one processing device to:
identify a plurality of data sources, wherein the plurality of data sources comprises a plurality of datasets;
generate at least one data center comprising a portion of the plurality of datasets, wherein the at least one data center comprises one or more datasets from a portion of data sources of the plurality of data sources, and wherein the at least one data center comprises a plurality of curation levels associated with the one or more datasets; and
generate a curation token for each curation level of the plurality of curation levels, wherein the curation token is associated with a specific dataset comprising the associated curation level of a specific data center.

2. The system of claim 1, wherein each curation level comprises at least one version identifier associated with an updated version for each dataset of the one or more datasets.

3. The system of claim 2, wherein executing the computer-readable code is further configured to cause the at least one processing device to:
generate, based on each curation level and the at least one version identifier, at least one tier indicator for each curation level, wherein each tier indicator comprises data source information for each dataset in each data center.

4. The system of claim 3, wherein executing the computer-readable code is further configured to cause the at least one processing device to:
generate, based on each tier indicator, a graphical neural network (GNN), wherein the GNN comprises each tier indicator and each curation token associated with each tier indicator;
identify at least one data transmission request; and
determine, by the GNN, at least one curation token based on the associated curation level and the at least one data source of the curation token, wherein the at least one curation token determined by the GNN is based on resolving the at least one data transmission request.

5. The system of claim 1, wherein executing the computer-readable code is further configured to cause the at least one processing device to:
identify at least one data transmission request token, wherein the at least one data transmission request token is generated from at least one historical data transmission request;
access a graphical neural network (GNN) using the at least one data transmission request token, wherein the GNN is pretrained with a plurality of tiers associated with a plurality of curation tokens;
determine, using the GNN, at least one dataset to resolve the at least one data transmission request token;
identify, by the GNN and based on the at least one dataset to resolve the at least one data transmission request, a curation level for the at least one dataset;
identify, by the GNN, a specific curation token associated with the at least one dataset and based on the at least one curation level identified for the at least one dataset;
apply the curation token to the data center associated with the curation token; and
access, based on the application of the curation token, the at least one dataset at the at least one curation level within the data center.

6. The system of claim 1, wherein the at least one data center comprises at least a portion of data from a plurality of data sources, and the portion of data is separated based on at least one of a curation level and a version identifier within the at least one data center.

7. The system of claim 1, wherein the plurality of data sources comprises a plurality of applications, databases, or repositories.

8. The system of claim 1, wherein the at least one dataset is one or an unstructured dataset or a structured dataset.

9. The system of claim 1, wherein the curation level is associated with at least one of a raw data of the portion of the plurality of datasets, a validated portion of the plurality of datasets, or an enriched portion of the plurality of datasets.

10. The system of claim 1, wherein the curation level is organized within the datacenter based on a tier identifier.

11. A computer program product for transforming data from disparate data sources into curated data centers comprising multi-tiered secure tokens, wherein the computer program product comprises at least one non-transitory computer-readable medium having computer-readable program code portions embodied therein, the computer-readable program code portions which when executed by a processing device are configured to cause the processor to:
identify a plurality of data sources, wherein the plurality of data sources comprises a plurality of datasets;
generate at least one data center comprising a portion of the plurality of datasets, wherein the at least one data center comprises one or more datasets from a portion of data sources of the plurality of data sources, and wherein the at least one data center comprises a plurality of curation levels associated with the one or more datasets; and
generate a curation token for each curation level of the plurality of curation levels, wherein the curation token is associated with a specific dataset comprising the associated curation level of a specific data center.

12. The computer program product of claim 11, wherein each curation level comprises at least one version identifier associated with an updated version for each dataset of the one or more datasets.

13. The computer program product of claim 12, wherein the computer-readable program code portions which when executed by the processing device are configured to cause the processor to:
generate, based on each curation level and the at least one version identifier, at least one tier indicator for each curation level, wherein each tier indicator comprises data source information for each dataset in each data center.

14. The computer program product of claim 13, wherein the computer-readable program code portions which when executed by the processing device are configured to cause the processor to:
generate, based on each tier indicator, a graphical neural network (GNN), wherein the GNN comprises each tier indicator and each curation token associated with each tier indicator;
identify at least one data transmission request; and
determine, by the GNN, at least one curation token based on the associated curation level and the at least one data source of the curation token, wherein the at least one curation token determined by the GNN is based on resolving the at least one data transmission request.

15. The computer program product of claim 11, wherein the computer-readable program code portions which when executed by the processing device are configured to cause the processor to:
identify at least one data transmission request token, wherein the at least one data transmission request token is generated from at least one historical data transmission request;
access a graphical neural network (GNN) using the at least one data transmission request token, wherein the GNN is pretrained with a plurality of tiers associated with a plurality of curation tokens;
determine, using the GNN, at least one dataset to resolve the at least one data transmission request token;
identify, by the GNN and based on the at least one dataset to resolve the at least one data transmission request, a curation level for the at least one dataset;
identify, by the GNN, a specific curation token associated with the at least one dataset and based on the at least one curation level identified for the at least one dataset;
apply the curation token to the data center associated with the curation token; and
access, based on the application of the curation token, the at least one dataset at the at least one curation level within the data center.

16. A computer implemented method for transforming data from disparate data sources into curated data centers comprising multi-tiered secure tokens, the computer implemented method comprising:
identifying a plurality of data sources, wherein the plurality of data sources comprises a plurality of datasets;
generating at least one data center comprising a portion of the plurality of datasets, wherein the at least one data center comprises one or more datasets from a portion of data sources of the plurality of data sources, and wherein the at least one data center comprises a plurality of curation levels associated with the one or more datasets; and
generating a curation token for each curation level of the plurality of curation levels, wherein the curation token is associated with a specific dataset comprising the associated curation level of a specific data center.

17. The computer implemented method of claim 16, wherein each curation level comprises at least one version identifier associated with an updated version for each dataset of the one or more datasets.

18. The computer implemented method of claim 17, further comprising:
generating, based on each curation level and the at least one version identifier, at least one tier indicator for each curation level, wherein each tier indicator comprises data source information for each dataset in each data center.

19. The computer implemented method of claim 18, further comprising:
generating, based on each tier indicator, a graphical neural network (GNN), wherein the GNN comprises each tier indicator and each curation token associated with each tier indicator;
identifying at least one data transmission request; and
determining, by the GNN, at least one curation token based on the associated curation level and the at least one data source of the curation token, wherein the at least one curation token determined by the GNN is based on resolving the at least one data transmission request.

20. The computer implemented method of claim 16, further comprising:
identifying at least one data transmission request token, wherein the at least one data transmission request token is generated from at least one historical data transmission request;
accessing a graphical neural network (GNN) using the at least one data transmission request token, wherein the GNN is pretrained with a plurality of tiers associated with a plurality of curation tokens;
determining, using the GNN, at least one dataset to resolve the at least one data transmission request token;
identifying, by the GNN and based on the at least one dataset to resolve the at least one data transmission request, a curation level for the at least one dataset;
identifying, by the GNN, a specific curation token associated with the at least one dataset and based on the at least one curation level identified for the at least one dataset;
applying the curation token to the data center associated with the curation token; and
accessing, based on the application of the curation token, the at least one dataset at the at least one curation level within the data center.
